(19) United States
(12) Patent Application Publication
(10) Pub. No.: US 2015/0061173 A1
(43) Pub. Date: Mar. 5, 2015

(54) FABRIC REINFORCING MATERIAL FOR URETHANE FOAM-MOLDING AND METHOD OF MANUFACTURING URETHANE FOAM-MOLDED PRODUCT USING THE SAME

(71) Applicants: TOYOTA BOSHOKU KABUSHIKI KAISHA, Aichi-ken (JP); MOLD TECHNICAL OFFICE CO., LTD., Kanagawa-ken (JP); VALUTEC INTERNATIONAL INC, Tokyo (JP)

(72) Inventors: Yoshiyuki MURATA, Aichi-ken (JP); Kensuke INUZUKA, Aichi-ken (JP); Toshio IWASAWA, Kanagawa (JP); Jun YAMAGAMI, Tokyo (JP)

(21) Appl. No.: 14/472,512

(22) Filed: Aug. 29, 2014

(30) Foreign Application Priority Data
Aug. 30, 2013 (JP) 2013-179955

(51) Int. Cl. B29C 45/14; D06M 15/333; D06M 15/59

(52) U.S. Cl. CPC B29C 45/14786; B29C 45/14065; D06M 15/59; D06M 15/333; B29K 2075/00
USPC 264/46.4; 442/164; 442/380

(57) ABSTRACT

There is provided a fabric reinforcing material for urethane foam-molding, which includes an organic fiber non-woven fabric which has a basis weight of 15 g/m² to 200 g/m², and a thermoplastic magnetic resin material which contains 10 to 80 percent by mass of a magnetic material powder having a mean particle diameter of 15 μm to 500 μm, and which is permeated in a portion of a surface of the organic fiber non-woven fabric and immobilized. Also, there is provided a method of manufacturing a urethane foam-molded product using the fabric reinforcing material.

### CROSS-REFERENCE TO RELATED APPLICATION

This application claims priority from Japanese Patent Application No. 2013-179955, filed on Aug. 30, 2013, the entire subject matter of which is incorporated herein by reference.

### BACKGROUND OF THE INVENTION

1. Field of the Invention

The present invention relates to a fabric reinforcing material for urethane foam-molding, and a method of manufacturing a urethane foam-molded product using the fabric reinforcing material, and more particularly, to a fabric reinforcing material which is used for urethane foam-molding, and is not damaged and does not wrinkle or slacken when it is handled during urethane foam-molding, and is easy to be set on a molding die, and prevents resin exuding, and a method of manufacturing a urethane foam-molded product using the fabric reinforcing material.

2. Description of the Related Art

In this specification, a thermoplastic magnetic resin material refers to a thermoplastic resin which contains a magnetic material such as ferrite and has magnetism, and which has a property that it is solid at normal temperature and is liquefied and fluidized by heating.

Conventionally, a fabric reinforcing material such as a cheesecloth or a non-woven fabric is used for a urethane foam-molded product to be used as a cushion for a vehicle seat or the like, in order to prevent noise due to contact with metal springs and prevent urethane exuding, and protect urethane from breakage. In manufacturing the urethane foam-molded product, the fabric reinforcing material obtained by cutting an original reinforcing fabric and sewing the cut fabric is set on a urethane foam-molded product molding die, and then liquid urethane is injected and foam-molded. In this case, a plurality of permanent magnets are buried in the urethane foam-molded product molding die, and plate-shaped magnetic material pieces are attached on the fabric reinforcing material by double-faced tape. Then, the fabric reinforcing material is temporarily fixed by a magnetic force between the magnetic material pieces provided on the fabric reinforcing material and the permanent magnets provided in the molding die (for example, JP-A-2001-252930).

Since the magnetic material pieces are generally rectangular sheet pieces, for example, when the fabric reinforcing material is moved or is set on the urethane foam-molded product molding die, corner portions of the magnetic material pieces attached by double-faced tape may be caught in fibers of the surface of the fabric reinforcing material, whereby the magnetic material pieces may be shifted or be peeled off. If the attachment positions of the magnetic material pieces are deviated from the positions of the magnets of the urethane foam-molded product molding die, slacks, wrinkles and distortion occur during foam-molding, resulting in problems such as poor appearance and non-uniform hardness of a urethane foam-molded product.

### SUMMARY

The present invention has been made in view of the above circumstances, and an object of the present invention is to provide a fabric reinforcing material for urethane foam-molding which can solve the above problems that a corner of a magnetic material piece is caught in fibers of a surface of a fabric reinforcing material to be shifted or peeled off, and in which a magnetic material piece is unlikely to be peeled off, and which is easy to be set on a urethane foam-molded product molding die, and provide a method of manufacturing a urethane foam-molded product using the fabric reinforcing material.

According to an illustrative embodiment of the present invention, there is provided a fabric reinforcing material for urethane foam-molding, which includes an organic fiber non-woven fabric which has a basis weight of 15 g/m² to 200 g/m², and a thermoplastic magnetic resin material which contains 10 to 80 percent by mass of a magnetic material powder having a mean particle diameter of 15 μm to 500 μm, and which is permeated in a portion of a surface of the organic fiber non-woven fabric and immobilized.

According to this configuration, since the thermoplastic magnetic resin material melt by heating permeates a portion of the non-woven fabric and is immobilized to form the fabric reinforcing material, the portion is not an acute portion and has a curved surface shape. Further, since the thermoplastic magnetic resin material permeates the non-woven fabric, although the thermoplastic magnetic resin material acts as a magnetic material, the thermoplastic magnetic resin material is unlikely to be peeled off or be shifted, and is not caught in fibers of the surface of the non-woven fabric.

In the above fabric reinforcing material, the organic fiber non-woven fabric may include a plurality of layers, and the thermoplastic magnetic resin material is permeated in at least a portion of at least a surface layer of the plurality of layers and immobilized.

According to this configuration, since the non-woven fabric having a function of absorbing and immobilizing the thermoplastic magnetic resin material is different from non-woven fabric having a function of preventing noise due to contact with a metal spring and preventing urethane exuding, it is possible to more simply achieve prevention of noise due to contact with a metal spring, prevention of urethane exuding, and securing of adhesion of the thermoplastic magnetic resin material to the non-woven fabric.

In the above fabric reinforcing material, a thermoplastic resin constituting the thermoplastic magnetic resin material may be one or more resins selected from the group consisting of ethylene-vinyl acetate copolymer resin, polypropylene resin, polyester resin, thermoplastic polyurethane resin, polyamide resin and saturated polyester resin.

According to this configuration, since the meltability of the thermoplastic resin is superior, it is possible to secure the extrusion moldability of the thermoplastic magnetic resin material, and secure adhesion of the thermoplastic magnetic resin material to the non-woven fabric.

According to another illustrative embodiment of the present invention, there is provided a method of manufacturing a urethane foam-molded product. The method includes: fixing the above-described fabric reinforcing material on a surface of a molding die having a magnet buried at a predetermined position, by a magnetic force; injecting a urethane resin into the molding die and foaming the urethane resin, thereby molding the urethane resin integrally with the fabric reinforcing material to form the urethane foam-molded product; and removing the urethane foam-molded product from the molding die.

According to this configuration, it is possible to use the fabric reinforcing material to manufacture a urethane foam-molded product in which a magnetic material is unlikely to be peeled or shifted and is not caught in fibers of the surface of the non-woven fabric, and which is superior in workability.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is an explanatory view showing a fabric reinforcing material for urethane foam-molding according to an illustrative embodiment of the present invention;

FIG. 2 is an explanatory view showing a cross section structure of the fabric reinforcing material for urethane foam-molding according to the illustrative embodiment to the present invention; and

FIG. 3 is an explanatory view showing a cross section structure of a related-art fabric reinforcing material for urethane foam-molding.

### DETAILED DESCRIPTION

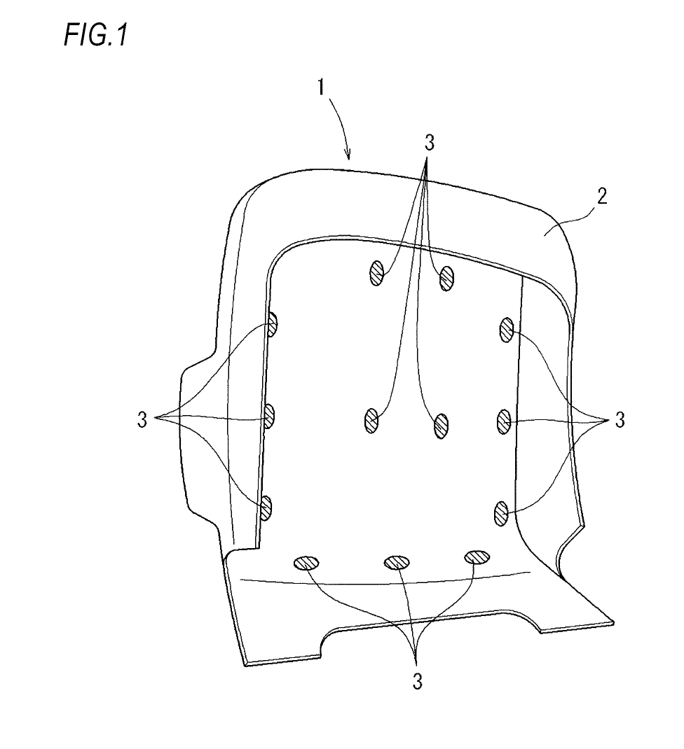

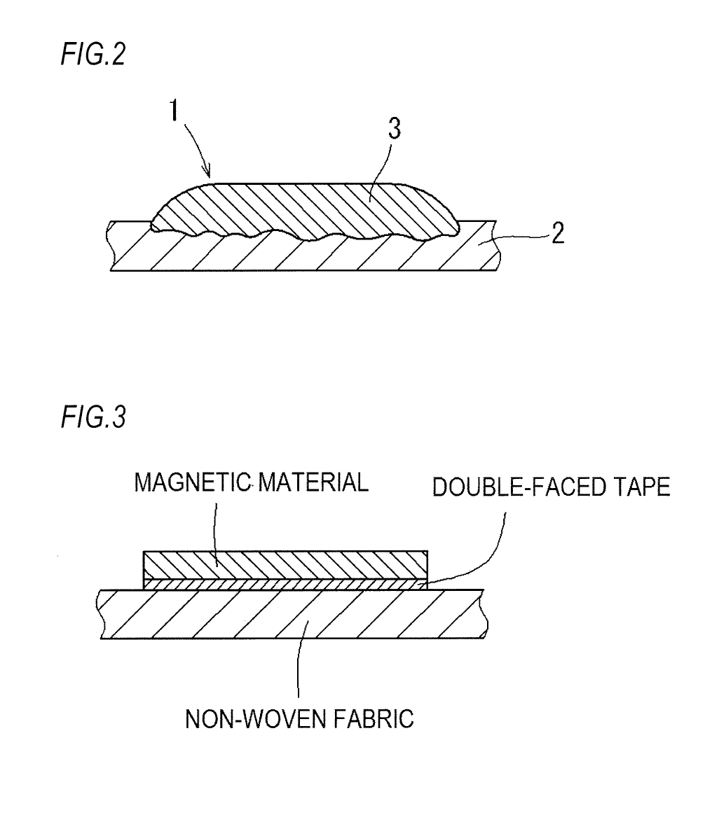

An illustrative embodiment of the present invention will be described with reference to FIGS. 1 and 2. FIG. 1 is an explanatory view showing a fabric reinforcing material for urethane foam-molding according to an illustrative embodiment of the present invention, and FIG. 2 is an explanatory view showing a cross section structure of the fabric reinforcing material.

A fabric reinforcing material 1 for urethane foam-molding according to an illustrative embodiment of the present invention includes an organic fiber non-woven fabric 2 which has a basis weight of 50 g/m² to 200 g/m² and a thermoplastic magnetic resin material 3 which contains 10 to 80 percent by mass of magnetic material powder having a mean particle diameter of 15 μm to 500 μm and which is permeated in a portion of a surface of the non-woven fabric 2 and immobilized.

The non-woven fabric 2 which is used in the fabric reinforcing material 1 according to the illustrative embodiment may be made of organic fibers and to have a basis weight of 50 g/m² to 200 g/m², preferably, 80 g/m² to 175 g/m². If the basis weight is less than 50 g/m², injected urethane is likely to exude and noise may be generated due to friction with a spring. If the basis weight exceeds 200 g/m², flexibility decreases, and thus wrinkles may be generated during molding.

The kind and thickness of fibers constituting the non-woven fabric 2 are not especially limited. The constituent fibers may be, for example, organic fibers composed of at least one of polyester fibers such as polyethylene telephthalate and polybutylene terephthalate, polyolefin fibers such as polyethylene and polypropylene (which may be a homopolymer or a copolymer like a random polymer), polyamide fibers. and the like. Preferably, polyester fibers, polypropylene fibers, polyethylene fibers, polyester fibers having a low melting point of 110° C. to 160° C., bicomponent fibers of polyester and polyethylene, bicomponent fibers of polyethylene and low-melting-point polyester, or bicomponent fibers of polypropylene and polyethylene can be used. Also, the constituent organic fiber may have a fiber diameter of 5 μm to 30 μm and a fineness (thickness) of 1 dtex to 33 dtex.

Also, the non-woven fabric 2 is not limited to a single layer fabric, and may be a multi-layer fabric obtained by laminating them.

The thermoplastic magnetic resin material 3 which is used in the illustrative embodiment is a thermoplastic resin containing magnetic material powder, has a property that it is solid at normal temperature and is liquefied and fluidized by heating, and has magnetism attracting a magnet. In this illustrative embodiment, the content of the magnetic material powder in the thermoplastic magnetic resin material 3 may be 10 to 80 percent by mass, preferably, 15 to 70 percent by mass. If the content of the magnetic material powder is less than 10 percent by mass, the force to attract and adhere to a magnet of a molding die becomes weak, and thus temporal fixing of the fabric reinforcing material may become insufficient, and the fabric reinforcing material is often wrinkled, slackened or shifted during molding. Meanwhile, if the content of the magnetic material powder exceeds 80 percent by mass, at forming of the thermoplastic magnetic resin material 3 with an extruder, a nozzle of the extruder tends to be clogged, whereby extrusion becomes difficult, and it becomes difficult to form the thermoplastic magnetic resin material 3.

The magnetic material powder may be powder of a ferromagnetic material such as iron, nickel, cobalt or an alloy of them, a rare-earth metal such as ferrite or gadolinium, an manganese alloy such as a Heusler alloy (Cu2MnAl), or a compound such as CrO₂, CrBr₃, or ZrZn2. The particle diameter may be 15 μm to 500 μm, preferably, 50 μm to 200 μm. If the particle diameter is less than 15 μm, in a case where the thermoplastic magnetic resin material 3 permeates the fabric reinforcing material 1 and is immobilized, the force to attract the magnet of the molding die becomes weak, and thus the fabric reinforcing material 1 may be wrinkled, slackened, or shifted during molding. If the particle diameter exceeds 500 μm, dispersion of the magnetic material powder may become insufficient, or in the case of using the extruder to form the thermoplastic magnetic resin material 3, extrusion may become difficult due to clogging of the nozzle, or it may be difficult to obtain the thermoplastic magnetic resin material 3 due to a trouble such as jamming.

A thermoplastic resin which is used as the thermoplastic magnetic resin material 3 may be an ethylene-vinyl acetate copolymer resin, a polypropylene resin, a modified polypropylene resin, a polyethylene resin, a modified polyethylene resin, a thermoplastic polyurethane resin, a polyamide resin (polyamide 6 or polyamide 66), a polyester resin (a polyethylene terephthalate resin or a polybutyrene terephthalate resin), a polyvinylchloride resin, or the like.

(1) However, it is preferable that the melting point of the thermoplastic resin be lower than the melting point of the organic fibers constituting the non-woven fabric 2. The reason is that in a case of immobilizing the thermoplastic magnetic resin material 3 in the non-woven fabric, if the melting point of the thermoplastic magnetic resin material 3 is higher than the melting point of the non-woven fabric, if the thermoplastic magnetic resin material 3 is melted and then is put on the non-woven fabric, or is put on the non-woven fabric and then melted by heating, the non-woven fabric 2 may be melted, whereby holes may be formed and thus the non-woven fabric 2 cannot be used as a fabric reinforcing material for a seat. For example, in a case where the constituent fibers of the non-woven fabric 2 are polyethylene terephthalate fiber (whose melting point 260° C.) or polypropylene fibers (whose melting point 165° C.), it is preferable to select a low-melting-point polyethylene resin (whose melting point of 98° C. to 132° C.), a polypropylene copolymer resin (whose melting point of 135° C. to 150° C.), or a polyester resin (whose melting point of 98° C. to 150° C.) having a melting point lower than the melting point of polyester fiber or polypropylene fiber, as the thermoplastic resin to be used as the thermoplastic magnetic resin material 3.

(2) Further, it is preferable to select a resin having a melting point higher than the molding temperature (normally, 60° C. to 80° C.) of a urethane foam-molding die. The reason is that if the melting point of the thermoplastic resin is lower than the molding temperature of the urethane foam-molding die, the thermoplastic resin may be re-melted. Also, in order to improve the dispersibility or fluidity of the magnetic material, it may be possible to mix 10 to 30 percent by mass of a glass filler, silica fiber, liquid paraffin, or the like in the thermoplastic magnetic resin material 3 which is used in this illustrative embodiment as long as the attracting property of the magnetic material to the magnet buried in the molding die is not damaged.

As shown in FIG. 2, the fabric reinforcing material 1 according to the illustrative embodiment is formed while the thermoplastic magnetic resin material 3 containing 10 to 80 percent by mass of the magnetic material powder permeates a portion of a surface of the non-woven fabric 2 composed of organic fibers and is immobilized. In other words, the thermoplastic magnetic resin material 3 is melted by heating, thereby becoming a liquid state, and then is applied or dropped onto a specific portion of the surface of the non-woven fabric 2. Then, after the liquid thermoplastic magnetic material permeates the non-woven fabric 2, the thermoplastic magnetic material is air-dried or cooled so as to become a solid state, thereby being immobilized. Here, the portion of the surface onto which the thermoplastic magnetic material is applied or dropped means a specific surface portion of the non-woven fabric 2. In a case where the non-woven fabric 2 has a multi-layer structure, the liquid thermoplastic magnetic resin material 3 applied or dropped onto a surface layer of the non-woven fabric 2 may permeate the non-woven fabric up to the lower layer and be immobilized.

In order to obtain the thermoplastic magnetic resin material 3, an extruder is used to mix and disperse the magnetic material powder in the thermoplastic resin while melting the thermoplastic resin, and extrude the melted mixture from a nozzle of the tip end of the extruder. The thermoplastic magnetic resin material 3 can be formed in a grain shape, a string shape, a fiber shape, a rod shape, or a planar shape so as to be able to correspond to the position and shape of a portion of the urethane foam-molding die to which the fabric reinforcing material will be attached. In a case where the thermoplastic magnetic resin material 3 has a planar shape, it is preferable that the thermoplastic magnetic resin material 3 should have a film shape, a sheet shape, a net shape, or a fabric shape. In a case of forming the thermoplastic magnetic resin material 3 in a grain shape, a general strand cutting method is used, and in a case of forming the thermoplastic magnetic resin material 3 in a rod shape, the extruded mixture is cooled and then is cut into a predetermined length. Also, in a case of forming the thermoplastic magnetic resin material 3 in a string shape, the thermoplastic magnetic resin material 3 is wounded around a reel by a general method of producing a string, and in a case of forming the thermoplastic magnetic resin material 3 in a film or sheet shape, a general T-die method is used. Further, in a case of forming the thermoplastic magnetic resin material 3 in a tape shape, the thermoplastic magnetic resin material 3 is formed in a film or sheet shape and is wound. Also, in a case of forming the thermoplastic magnetic resin material 3 in a fabric shape, particularly, a non-woven fabric shape, a multi-hole nozzle for producing hot melt non-woven fabric may be attached to the tip end of the extruder, and the thermoplastic magnetic resin material 3 may be formed by the same method as a method of producing a hot melt non-woven fabric.

Since the thermoplastic magnetic resin material 3 which is used in the illustrative embodiment is melted and fluidized by energy such as heat or an ultrasonic wave, the thermoplastic magnetic resin material 3 can permeate a fiber layer of the fabric reinforcing material, and is likely to be molded in a required shape by the urethane foam-molding die during cooling. Therefore, it is possible to immobilize the magnetic material in a required shape at a target position of the fabric reinforcing material. In order to cause the thermoplastic magnetic resin material 3 to permeate the non-woven fabric 2 and immobilize the thermoplastic magnetic resin material 3, for example, the following methods can be used.

(1) A first method includes: setting an original non-woven fabric; disposing a predetermined amount of thermoplastic magnetic resin material 3 in a predetermined size on a predetermined portion of the original non-woven fabric; heating the thermoplastic magnetic resin material 3 by a heating plate such as an iron, such that the thermoplastic magnetic resin material 3 is melted and permeates the non-woven fabric; and cooling the thermoplastic magnetic resin material 3 while pressing the thermoplastic magnetic resin material 3 with a cool metal rod or the like, thereby immobilizing the thermoplastic magnetic resin material 3.

(2) A second method includes: disposing a predetermined amount of thermoplastic magnetic resin material 3 in a predetermined size on a predetermined portion of a molding die; setting the non-woven fabric thereon, heating the thermoplastic magnetic resin material 3 from above by a heating plate such as an iron, such that the thermoplastic magnetic resin material 3 is melted and permeates the non-woven fabric 2; and cooling the thermoplastic magnetic resin material 3 while pressing the thermoplastic magnetic resin material 3 with a cool metal rod or the like, thereby immobilizing the thermoplastic magnetic resin material 3. In this case, during heating, it is preferable to interpose a Teflon (registered trademark) film as a separating material between the thermoplastic magnetic resin material 3 and the heat source.

(3) A third method includes: melting the thermoplastic magnetic resin material 3 having a grain shape, extruding the thermoplastic magnetic resin material 3 in a tape shape, a fiber shape, a dot shape, a line shape, or a net shape from the discharge nozzle of a hot melt application apparatus using a T-die method, a spraying method, a rotogravure roll method, or the like, thereby applying the thermoplastic magnetic resin material 3 onto a predetermined portion of the non-woven fabric; and cooling and immobilizing the thermoplastic magnetic resin material 3. In this case, since the thermoplastic magnetic resin material 3 can be applied on a predetermined portion, it is possible to improve work efficiency.

A method of forming a urethane foam-molded product using the above-described third method will be described in more detail. Roughly-cut sheet-shaped non-woven fabric is fixed to a die having a plurality of air holes extending from the outer surface to an internal space, and the die is covered with a film having heat resistance, and the inside of the film is heated by high-temperature steam. Thereafter, the inside of the film is depressurized, whereby the shape of the die is transferred to the sheet-shaped non-woven fabric. After the die is cooled, the molded non-woven fabric is removed from the die. Then, the thermoplastic magnetic resin material 3 is extruded in a tape shape from the discharge nozzle of the hot melt application apparatus using a T-die method, thereby being applied onto a predetermined portion of the molded non-woven fabric, and then is cooled and immobilized.

The non-woven fabric having the thermoplastic magnetic resin material 3 fixed at the predetermined portion is set on the urethane foam-molding die having the magnet buried at the predetermined position, and a urethane resin is injected and foamed. The urethane foam-molded product integrally with the non-woven fabric is removed from the die, and is taken out.

### EXAMPLES AND COMPARATIVE EXAMPLES

Subsequently, the present invention will be described based on specific examples of the present invention while contrasting the examples with comparative examples. However, the present invention is not limited thereto.

A method of forming a fabric reinforcing material used in each of the following examples is as follows, and the comparative examples are based on the similar producing method.

(Forming Thermoplastic Magnetic Resin Material 3)

As an apparatus for mixing the thermoplastic resin and the magnetic material, thereby forming the thermoplastic magnetic resin material 3, a general single screw extruder was used, and the thermoplastic resin and the magnetic material were continuously and simultaneously supplied into the extruder, and were mixed while being melted by heating, whereby the thermoplastic magnetic resin material 3 having a columnar grain shape having a diameter of 2 mm and a length of 5 mm was obtained.

(Organic Fiber Non-Woven Fabric)

A dry non-woven fabric was formed of fibers obtained by mixing 70 percent by mass of polyester short fiber (whose fineness is 2.2 dtex) and 30 percent by mass of bicomponent short fiber of polyethylene and polypropylene, by a carding method, so as to have a single layer structure having a basis weight of 140 g/m².

(Forming Fabric Reinforcing Material)

Ten grains of the thermoplastic magnetic resin material 3 obtained as described above were put on an iron table, and the above-described organic fiber non-woven fabric was spread thereon, so as to cover the grains, and a Teflon (registered as a trade mark) film for separation was spread, and was pressed from above by an iron controlled to 190° C. by a temperature control dial, for 10 seconds, such that the thermoplastic magnetic resin material was heated, thereby being melted so as to become a liquid state, and permeated the non-woven fabric, and then the thermoplastic magnetic resin material is cooled by contact with a cool metal rod, whereby the fabric reinforcing material 1 was obtained.

### Example 1

As the thermoplastic resin, 90 percent by mass of an ethylene-vinyl acetate copolymer resin (whose melting point 94° C.) was used, and as the magnetic material, 10 percent by mass of ferrite powder which is composed of strontium, magnesium, manganese and iron, and which has a mean particle size of 35 μm was used, whereby a thermoplastic magnetic resin material 3 was formed in a grain shape, and then a fabric reinforcing material 1 was obtained by the above-described method.

### Example 2

As the thermoplastic resin, 70 percent by mass of an ethylene-vinyl acetate copolymer resin (whose melting point 94° C.) was used, and as the magnetic material, 10 percent by mass of iron powder having a mean particle size of 80 μm was used, whereby a thermoplastic magnetic resin material 3 was formed in a grain shape, and then a fabric reinforcing material 1 was obtained by the above-described method.

### Example 3

As the thermoplastic resin, 40 percent by mass of an ethylene-vinyl acetate copolymer resin (whose melting point 94° C.) was used, and as the magnetic material, 60 percent by mass of ferrite powder which is composed of strontium, magnesium, manganese and iron, and which has a mean particle size of 35 μm was used, whereby a thermoplastic magnetic resin material 3 was formed in a grain shape, and then a fabric reinforcing material 1 was obtained by the above-described method.

### Example 4

As the thermoplastic resin, 20 percent by mass of an ethylene-vinyl acetate copolymer resin (whose melting point 94° C.) was used, and as the magnetic material, 80 percent by mass of ferrite powder which is composed of manganese and iron and which has a mean particle size of 80 μm, whereby a thermoplastic magnetic resin material 3 was formed in a grain shape, and then a fabric reinforcing material 1 was obtained by the above-described method.

### EXAMPLE 5

As the thermoplastic resin, 60 percent by mass of an ethylene-vinyl acetate copolymer resin (whose melting point 80° C.) was used, and as the magnetic material, 40 percent by mass of iron powder having a mean particle size of 80 μm, whereby a thermoplastic magnetic resin material 3 was formed in a grain shape, and then a fabric reinforcing material 1 was obtained by the above-described method.

### Example 6

As the thermoplastic resin, 60 percent by mass of a polyamide resin (whose melting point 90° C.) was used, and as the magnetic material, 40 percent by mass of iron powder having a mean particle size of 80 μm was used, whereby a thermoplastic magnetic resin material 3 was formed in a grain shape, and then a fabric reinforcing material 1 was obtained by the above-described method.

### Example 7

As the thermoplastic resin, 60 percent by mass of a low-melting-point polyester resin (whose melting point 115° C.) was used, and as the magnetic material, 40 percent by mass of iron powder having a mean particle size of 80 μm, whereby a thermoplastic magnetic resin material 3 was formed in a grain shape, and then a fabric reinforcing material 1 was obtained by the above-described method.

### Comparative Example 1

As the thermoplastic resin, 95 percent by mass of an ethylene-vinyl acetate copolymer resin (whose melting point 94° C.) was used, and as the magnetic material, 5 percent by mass of ferrite powder which is composed of strontium, magnesium, manganese and iron, and which has a mean particle size of 35 μm was used, whereby a thermoplastic resin containing the magnetic material was formed in a grain shape, and then a fabric reinforcing material was obtained using this thermoplastic resin containing the magnetic material.

### Comparative Example 2

As the thermoplastic resin, 10 percent by mass of an ethylene-vinyl acetate copolymer resin (whose melting point 94° C.) was used, and as the magnetic material, 90 percent by mass of ferrite powder which is composed of strontium, magnesium, manganese and iron, and which has a mean particle size of 35 μm was used, whereby it was tried to form a thermoplastic resin containing the magnetic material in a grain shape. However, extrusion from the extruder could not be performed, and a thermoplastic magnetic resin material could not be obtained due to a jamming trouble.

### Comparative Example 3

As the thermoplastic resin, 90 percent by mass of an ethylene-vinyl acetate copolymer resin (whose melting point 94° C.) was used, and as the magnetic material, 10 percent by mass of ferrite powder which is composed of strontium, magnesium, manganese and iron, and which has a mean particle size of 5 μm was used, whereby a thermoplastic resin containing the magnetic material was formed in a grain shape, and then a fabric reinforcing material was obtained using this thermoplastic resin containing the magnetic material by the above-described method.

### Comparative Example 4

As the thermoplastic resin, 20 percent by mass of an ethylene-vinyl acetate copolymer resin (whose melting point 94° C.) was used, and as the magnetic material, 80 percent by mass of iron powder having a mean particle size equal to or larger than 500 μm was used, whereby it was tried to form a thermoplastic resin containing the magnetic material in a grain shape. However, extrusion from the extruder could not be performed, and a thermoplastic magnetic resin material could not be obtained due to a jamming trouble.

(Evaluation of Fabric Reinforcing Material)

The obtained fabric reinforcing materials were evaluated as follow.

The thermoplastic resins containing magnetic materials of the comparative examples were evaluated as thermoplastic magnetic resin material 3.

(a) Adhesion (Attractive Force) of Thermoplastic Magnetic Resin Material 3 to Magnet

A permanent magnet (2,800 G) having a weight of 10 g and a diameter of 6 mm was brought into contact with each thermoplastic magnetic resin material 3 having permeated and immobilized in the fabric reinforcing material, and was lifted, whereby adhesion (attractive force) was evaluated.

A reference symbol “A” represents that the magnet is completely lifted up into the air.

A reference symbol “B” represents that the magnet is lifted up, but is easy to fall down by a slight touch.

A reference symbol “C” represents that the magnet is not lifted up.

(B) Integrity (Fixed Force) of Thermoplastic Magnetic Resin Material 3 to Fabric Reinforcing Material

Each thermoplastic magnetic resin material 3 fixed to a fabric reinforcing material was peeled with hands, and the integrity was visually evaluated based on the damaged state of the peeled surface of the non-woven fabric.

A reference symbol “A” represents that unless an attempt to forcibly peel off the thermoplastic magnetic resin material is made, the thermoplastic magnetic resin material cannot be peeled off, or that if the thermoplastic magnetic resin material can be peeled off, a lot of fuzz on the non-woven fabric surface is recognized or there is great damage such as generation of a hole.

A reference symbol “B” represents that the thermoplastic magnetic resin material can be peeled off with a small force, and a few of fuzz on the non-woven fabric is appeared.

A reference symbol “C” represents that the fabric reinforcing material is easily peeled off without being damaged, and there is no great damage even on the non-woven fabric.

<Overall Evaluation Level>

Overall evaluation is represented by four levels denoted by reference symbols “S”, “A”, “B” and “C”.

The reference symbol “S” represents a best level (very satisfactory level).

The reference symbol “A” represents an excellent level (satisfactory level).

The reference symbol “B” represents a good level (usable level with some problems).

The reference symbol “C” represents that a bad level (unsatisfactory level).

The evaluation results are shown in Table 1 and Table 2.

TABLE 1
EXAMPLES

| | | | Example 1 | Example 2 | Example 3 | Example 4 | Example 5 | Example 6 | Example 7 |
|---|---|---|---|---|---|---|---|---|---|
| Thermoplastic | Thermoplastic Resin | | EVA1) | EVA1) | EVA1) | EVA1) | EVA2) | Poly- | Poly- |
| Magnetic | (Melting Point) | | 94° C. | 94° C. | 94° C. | 94° C. | 80° C. | amide | ester |
| Resin | | | | | | | | 90° C. | 115° C. |
| Material | Magnetic | Mass | 10% | 30% | 60% | 80% | 40% | 40% | 40% |
| | Material | Kind | (1) | (2) | (1) | (3) | (2) | (2) | (2) |
| | | | Ferrite | Iron | Ferrite | Ferrite | Iron | Iron | Iron |
| | | | | Powder | | | Powder | Powder | Powder |
| | | Mean | 35 μm | 80 μm | 35 μm | 80 μm | 80 μm | 80 μm | 80 μm |
| | | Particle | | | | | | | |
| | | Diameter | | | | | | | |

| | | | | | | | | |
|---|---|---|---|---|---|---|---|---|
| | Moldability | A | A | A | A | A | A | A |
| | Fluidity | A | A | A | B | A | A | A |
| Fabric | Adhesion with | B | A | A | A | A | A | A |
| Reinforcing | Magnet | | | | | | | |
| Material | Integrity | A | A | A | A | A | A | A |
| | Wrinkle/Slack | A | A | A | A | A | A | A |

| | | | | | | | |
|---|---|---|---|---|---|---|---|
| Overall Evaluation | A | S | A | A | A | A | A |

TABLE 2
COMPARATIVE EXAMPLES

| | | | Comparative | Comparative | Comparative | Comparative |
|---|---|---|---|---|---|---|
| | | | Example 1 | Example 2 | Example 3 | Example 4 |
| Thermoplastic | Thermoplastic Resin | | EVA1) | EVA1) | EVA1) | EVA1) |
| Magnetic | (Melting Point) | | 94° C. | 94° C. | 94° C. | 94° C. |
| Resin | Magnetic | Mass | 5% | 90% | 10% | 80% |
| Material | Material | Kind | (1) | (1) | (1) | (4) |
| | | | Ferrite | Ferrite | Ferrite | Iron Powder |
| | | Mean | 35 μm | 35 μm | 51 μm | 500 μm |
| | | Particle | | | | or larger |
| | | Diameter | | | | |

| | | | | | |
|---|---|---|---|---|---|
| | Moldability | A | C | A | C |
| | Fluidity | A | C | A | C |
| | | | Thermoplastic | | Thermoplastic |
| | | | magnetic resin | | magnetic resin |
| | | | material | | material |
| | | | cannot be | | cannot be |
| | | | obtained | | obtained |
| Fabric | Adhesion with Magnet | C | — | B | — |
| Reinforcing | Integrity | A | — | A | — |
| Material | Wrinkle/Slack | C | — | C | — |

| | | | | |
|---|---|---|---|---|
| Overall Evaluation | C | C | C | C |

The magnetic materials in Tables 1 and 2 represent the following magnetic materials.

The magnetic material (1) represents ferrite which is composed of iron, manganese, magnesium and strontium, and which has a saturation magnetization of 70 emu/g and has a mean particle size of 35 μm.

The magnetic material (2) represents iron powder having a mean particle size of 80 μm.

The magnetic material (3) represents ferrite which his composed of iron and manganese, and which has a saturation magnetization of 94 emu/g, and has a mean particle size of 80 μm.

The magnetic material (4) represents iron powder having a mean particle size 500 μm or larger.

(Results)

As apparent from Tables 1 and 2, in the comparative example 1 in which the thermoplastic magnetic resin material 3 contains 5 percent by mass of the magnetic material, the adhesion (sticking force) with the magnet becomes insufficient, and the fabric reinforcing material is wrinkled or slackened, and in the comparative example 2 in which the thermoplastic magnetic resin material contains 90 percent by mass of the magnetic material, it becomes difficult to obtain the thermoplastic magnetic resin material by the extruder, and thus a fabric reinforcing material appropriate for urethane foam-molding cannot be obtained. In the comparative example 3 in which the mean particle diameter of the magnetic material is 5 μm, the adhesion (sticking force) with the magnet becomes insufficient, and the fabric reinforcing material is wrinkled or slackened, and in the comparative example 4 in which the mean particle diameter of the magnetic material is 500 μm or larger, it becomes difficult to obtain the thermoplastic magnetic resin material by the extruder, and thus a fabric reinforcing material appropriate for urethane foam-molding cannot be obtained. In contrast, according to the present invention, since the thermoplastic magnetic resin material 3 contains 10 to 80 percent by mass of the magnetic material, and the mean particle diameter of the magnetic material is 15 μm to 500 μm, the excellent fabric reinforcing material 1 for urethane foam-molding which has sufficient adhesion (sticking force) with the magnet and which is unlikely to be wrinkled or slackened can be obtained.

What is claimed is:

1. A fabric reinforcing material for urethane foam-molding, comprising:
an organic fiber non-woven fabric which has a basis weight of 15 g/m² to 200 g/m²; and
a thermoplastic magnetic resin material which contains 10 to 80 percent by mass of a magnetic material powder having a mean particle diameter of 15 μm to 500 μm, and which is permeated in a portion of a surface of the organic fiber non-woven fabric and immobilized.

2. The fabric reinforcing material according to claim 1,
wherein the organic fiber non-woven fabric includes a plurality of layers, and the thermoplastic magnetic resin material is permeated in at least a portion of at least a surface layer of the plurality of layers and immobilized.

3. The fabric reinforcing material according to claim 1,
wherein a thermoplastic resin constituting the thermoplastic magnetic resin material is one or more resins selected from the group consisting of ethylene-vinyl acetate copolymer resin, polypropylene resin, polyester resin, thermoplastic polyurethane resin. polyamide resin and saturated polyester resin.

4. The fabric reinforcing material according to claim 1,
wherein a melting point of the thermoplastic resin constituting the thermoplastic magnetic resin material is lower than a melting point of organic fibers constituting the organic fiber non-woven fabric.

5. A method of manufacturing a urethane foam-molded product, the method comprising:
fixing the fabric reinforcing material according to claim 1 on a surface of a molding die having a magnet buried at a predetermined position, by a magnetic force;
injecting a urethane resin into the molding die and foaming the urethane resin, thereby molding the urethane resin integrally with the fabric reinforcing material to form the urethane foam-molded product; and
removing the urethane foam-molded product from the molding die.
